(19) United States
(12) Patent Application Publication
(10) Pub. No.: US 2006/0168121 A1
(43) Pub. Date: Jul. 27, 2006

(54) Method and system for storing and retrieving personal information

(76) Inventor: Sarah Rubinstein, B'nai Brak (IL)

Correspondence Address: LADAS & PARRY, 26 WEST 61ST STREET, NEW YORK, NY, 10023, US

(21) Appl. No.: 10/534,223

(22) PCT Filed:
(86) PCT No.: PCT/IL03/00961

(30) Foreign Application Priority Data
Nov. 14, 2002 (IL) 152862

(51) Int. Cl. G06F 15/16

(52) U.S. Cl. 709/219; 709/200; 709/203

(57) ABSTRACT

A method for storing and retrieving personal information adapted to improve the level of contentment of a user (30). A database (11) is provided, for storing therein and retrieving therefrom information that is related to sources of contentment. Each of the sources of contentment is associated with a different aspect of the user's life. Categories by which the information is to be stored in and retrieved from the database (11) are determined. The database (11) is updated by storing information that is related to a source of contentment. The information is stored in a unique location of the database and categorized according to a definition of each of the categories. The user (30) can access one or more unique locations of the database (11) in which categorized information of interest is stored. Upon receiving a request from the user (30), the categorized information of interest is transmitted and/or displayed to a user interface and reviewed.

### FIELD OF THE INVENTION

The present invention relates to the field of data storage and retrieval. More particularly, the present invention relates to a method and system for providing a user with desirable, positive information about himself by storing categorized data relating to such information and by retrieving and reviewing the stored data, which may have been forgotten.

### BACKGROUND OF THE INVENTION

Happiness is a basic human desire. Besides acquiring an agreeable feeling and a state of contentment concerning his daily activities, a happy person tends to be more energetic and his accomplishments improve both quantitatively and qualitatively, his self-confidence increases, and family members and friends enjoy his company. Children of happy parents demonstrate sound intellectual and social development.

Each person has a different perception as to what constitutes happiness. For example, economic gain provides happiness for some people, while for others, happiness is attained during intellectual pursuits. Thus, the causes of happiness are individually based.

A deterrent to achieving a state of contentment is the overemphasis on failures or other negative aspects of one's life. For example, an individual whose financial situation greatly influences his level of happiness may be unhappy due to a loss in the stock market, even if the loss itself has a very minor effect on his economic situation, while a student who places high importance to his marks may view receiving a B instead of an A as a failure, even if the B is above the average mark.

Group therapy has recently provided a way of improving one's feeling of self worth and contentment. A group of people usually meet together a counselor, who directs the discussion and offers advice. Each participant generally discusses various aspects of his life in front of others. The comments of the other participants may provide to the one who addressed the pressing problem under discussion a different view on his life, suggesting that the pressing problem can be overcome and that other aspects of his life have greater influence, and therefore assist him in becoming a happier person. However, those group therapy sessions have a drawback since some people feel debased when they expose their private reflections and vulnerabilities to others. Also, each group therapy session may last several hours, and the participants therefore have to forfeit other activities in their lives in order to participate in the sessions, in addition to incurring added expenses, such as entrance fees, transportation costs, etc.

It is therefore an object of the present invention to provide a method and system for data storage and retrieval adapted to improve the level of contentment.

It is another object of the present invention to provide a method and system for improving a level of contentment by identifying, storing and retrieving upon demand satisfying aspects of one's life.

It is a further object of the present invention to provide a method and system for achieving the above objects without having to expose one's vulnerabilities to others.

It is a further object of the present invention to provide a method and system for achieving the above objects without investing an inordinate amount of time or money.

Other objects and advantages of the invention will become apparent as the description proceeds.

### SUMMARY OF THE INVENTION

The invention comprises a method for storing and retrieving personal information adapted to improve the level of contentment of a user, which comprises:

a) Providing a database, for storing therein and retrieving therefrom information related to sources of contentment, each of said sources of contentment being associated with a different aspect of said user's life;

b) Determining categories by which said information is to be stored in and retrieved from said database;

c) Updating said database by storing information related to a source of contentment, said information being stored in a unique location of said database and categorized according to a definition of each of said categories;

d) Allowing said user to access one or more unique locations of said database in which categorized information of interest is stored;

e) Transmitting and/or displaying to a user interface, upon request from said user, said categorized information of interest; and

f) Reviewing said transmitted and/or displayed categorized information of interest.

As referred to herein, a “level of contentment” is that degree of contentment perceived by a user as a result of a multiplicity of personal events, activities, accomplishments, and interpersonal relationships—herein defined as “sources of contentment”—that are memorable during the course of his life. “Information” is data which is input to, and stored within, the database and which characterizes the user in terms of a particular source of contentment. Information is categorized according to “divisions” within the database, and each division may be categorized in hierarchal fashion.

In one preferred embodiment, the categorized information is arranged by divisions such that each category is divided into groups, each group being divided into properties and each property being divided into details.

The categorized information is preferably transmitted and/or displayed after the user requests to browse the stored categorized information and selects a desired division from a list of corresponding divisions.

In one aspect, the list of divisions transmitted and/or displayed to the user lists only those divisions for which information has been stored. Accordingly, all information stored in the database will be transmitted to the user, upon request from the user, according to the division in which it was stored.

The information is selected from the group of voice information, digital information, multimedia information and textual information.

The user interface is selected from the group of TUI (Telephonic User Interface), GUI (Graphical User Interface), an interactive television user interface and a text-based user interface.

In one aspect, the database is accessible through a data network. The data network is selected from the group of a telephone network, an Internet network, an Intranet network, and a television network of coaxial cables.

Preferably, authorization is required prior to updating the database or browsing the stored categorized information.

In one aspect, the database can be updated by authorized individuals, in addition to the user.

In another embodiment of the invention, the database is at least one board adapted for use in a card game, each of said boards being divided into a number of cells which are arranged as a table of rows and columns, such that each cell corresponds to a different division of categorized information, whereby a player updates the database by placing a card on which is written information related to a source of contentment into a desired cell.

The user becomes accustomed to viewing his life from an optimistic perspective by retrieving the stored categorized information on a regular basis.

The present invention also comprises a system for storing and retrieving personal information adapted to improveing the a level of contentment of a user, comprising:

A database, for storing therein and retrieving therefrom categorized information related to sources of contentment, each of said sources of contentment being associated with a different aspect of said user's life;

A controller, for managing transmission of information between said user and said database;

A user interface for communicating with said controller; and

A contentment source guide transmitted by said controller to said user interface which lists divisions of categorized information upon selection of a desired type of division by said user, information being stored in and retrieved from said database according to a selected division included within a list of said desired type of division,

said controller being adapted to transmit from said database to said user interface, upon request from said user, stored categorized information according to each division selected by the user.

As referred to herein, a “controller” is a hardware component or a software tool which manages the transmission of information from the user to the database, or vice versa, such that information is stored in and retrieved from a unique location in the database determined by said controller, in accordance with a division selected by the user.

A “contentment source guide” and “list of divisions” are used herein interchangeably to indicate a displayed menu of a desired hierarchal level of divisions transmitted from the controller to the user. A division selected from said menu serves as a cross reference to another hierarchal level, and alternatively, upon a request from the user, serves as a means of communicating with the controller as to which division information is to be input or retrieved.

The contentment source guide is selected from the group of an audible menu, graphic menu and textual menu.

In one embodiment of the present invention, the database, system manager and user interface are hosted by a personal computer.

### BRIEF DESCRIPTION OF THE DRAWINGS

In the drawings:

FIG. 1 illustrates an exemplary contentment source guide, according to a preferred embodiment of the invention;

FIG. 2 illustrates an exemplary secondary contentment source guide, linked to the contentment source guide of FIG. 1;

FIG. 3 illustrates another secondary contentment source guide, linked to the contentment source guide of FIG. 1;

FIG. 4 schematically illustrates a telephonic-based contentment source guide system, according to one embodiment of the invention;

FIG. 5 schematically illustrates a computerized center corresponding to the system of FIG. 4;

FIG. 6 schematically illustrates an Internet-based system contentment source guide system, according to another embodiment of the invention;

FIG. 7 schematically illustrates a computerized center corresponding to the system of FIG. 6;

FIG. 8 schematically illustrates a contentment source guide system which is independent from an external data network, according to another embodiment of the invention;

FIG. 9 illustrates a card game for improving the contentment level of a player, according to another embodiment of the present invention; and

FIG. 10 illustrates a plurality of boards used in the card game of FIG. 9.

### DETAILED DESCRIPTION OF PREFERRED EMBODIMENTS

In order to facilitate the reading of the description to follow, a number of terms and acronyms are defined below:

The Internet, or WWW (World Wide Web), is a worldwide system of computer networks in which users at any one computer can, if they are authorized, receive information from another computer.

Intranet is a private network within a company or an organization which generally uses the same software tools that are associated with the Internet.

A Web site is a related collection of WWW files that includes an opening file called a home page. From the home page one can proceed to all the other pages on the site. The Web site may comprise also one or more software components which produce Web pages or equivalents, to be sent to a user, usually while browsing said Web site.

A Web Browser is a software program that allows people to access the World Wide Web. Internet Explorer and Netscape Navigator are the two most popular Web browsers.

A Web server is one or more computer(s) that store the information (Web pages) that Internet users access via their Web browser and/or a program. A Web server can host one or more Web sites.

A Web page (document) is a specially formatted document that a user can view in his Web browser. Common languages for Web pages are HTTP, JavaScript, Jave, Vbscript, ASP.

A Web terminal is a computer-based machine that can “talk to” the Internet—that is, it contains a Web browser (which is really a Hypertext Transfer Protocol client) and the Internet's main program, TCP/IP.

An Application program is a program designed to perform a specific function directly for the user or, in some cases, for another application program. Applications use the services of the computer's operating system and other supporting applications.

Multimedia is the use of computers to present text, graphics, video, animation and voice in an integrated way.

Multimedia files are files comprising multimedia information, such as voice and video. The data stored on such files in a standard format. For example, JPG, BMP and GIF are image files, MPG is a standard for video file, and WAV is a standard for voice file.

A database is a collection of data that is organized so that its contents can easily be accessed, managed, and updated. Databases contain aggregations of data records or files, such as customer profiles. Typically, a database manager provides users the capabilities of controlling read/write access, specifying report generation, and analyzing usage.

A User Interface (UI) is the means with which a user interacts with a computerized system. A UI can include a display screen, keyboard, mouse, light pen, illuminated characters, help messages, etc.

A Graphical User Interface (GUI) is a user interface which uses pictorial buttons (icons) and command lists controlled by a pointing device such as mouse.

A Text-based User Interface is a user interface whose input is textual, e.g. a command line.

The method described herein provides an optimistic perspective of one's life by retrieving and reviewing significant achievements previously input into a data base, whereby and therefore negative aspects of his one's life are Reemphasized. In order to obtain an optimistic perspective of one's life, in accordance with the present invention, information regarding the individual has to be initially compiled and classified into several categories.

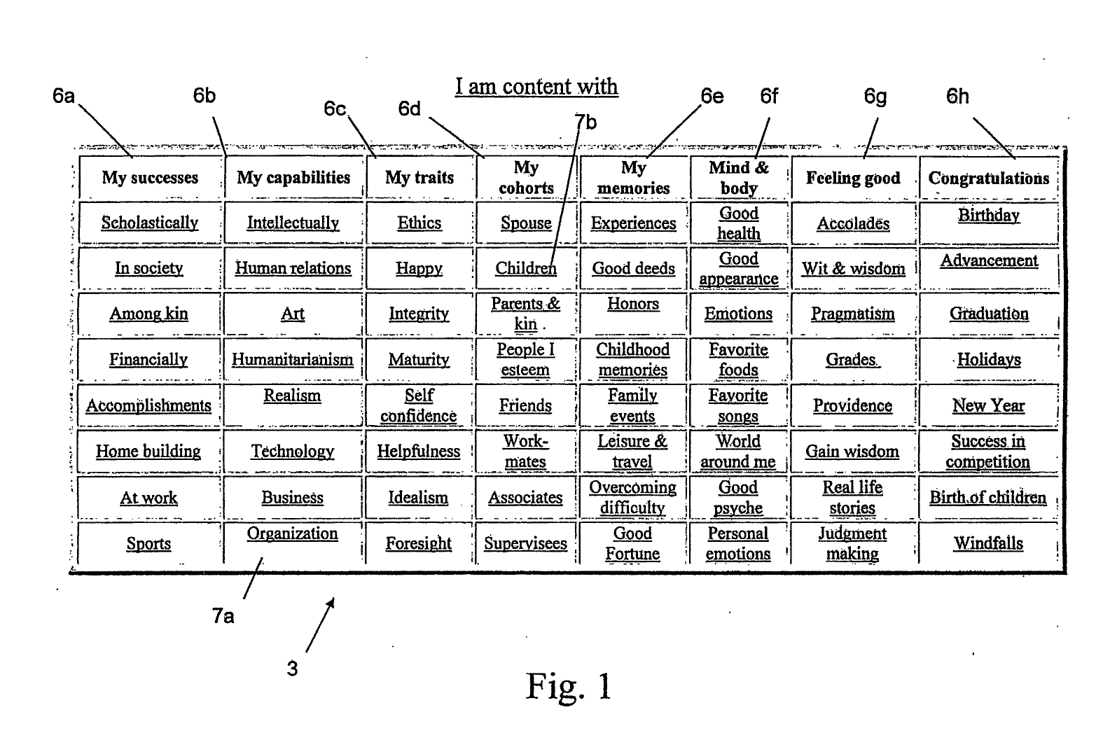

FIG. 1 schematically illustrates a contentment source guide, generally indicated by numeral 3, according to a preferred embodiment of the invention. A contentment source guide is a menu which lists various sources of contentment and guides a user to a more detailed list of the sources of contentment. By selecting a particular source of contentment, a user may store and retrieve information associated with the selected source of contentment, as will be described hereinafter. Upon retrieval and review of the stored information, the user recalls previously forgotten sources of contentment and realizes that his sources of contentment greatly outnumber his sources of aggravation or frustration. Thus the user improves his level of contentment during review of the retrieved information by understanding that a certain source of aggravation or frustration is only one detail among a significantly larger number of sources of contentment;

Contentment source guide 3 tabulates, by example, sources of contentment into eight main categories 6a-h: my successes, my capabilities, my traits, my cohorts, my memories, mind and body, feeling good and congratulations, respectively. Each of these categories represents a different source of contentment, and allows a user to retrieve a personal detailed list for each source of contentment, as will be described hereinafter. It will be appreciated that any other number of categories may be provided, if so desired by a user, to maximize the level of contentment.

Each category in turn is divided into groups, e.g. eight groups, two of which are indicated by numerals 7a and 7b, for classifying a particular source of contentment into distinct disciplines. For example, category 6a of successes is divided into the groups of scholastic success, success in society, success among kin, financial success, success in terms of accomplishments, success in terms of home building, success at work and success in sports, and the category of my cohorts is sub-divided into the groups of spouse, children, parents and kin, people I esteem, friends, workmates, associates, and supervisees. Each of the 64 tabulated groups defines a different aspect of one's life, and allows a user to categorize his sources of contentment according to these aspects.

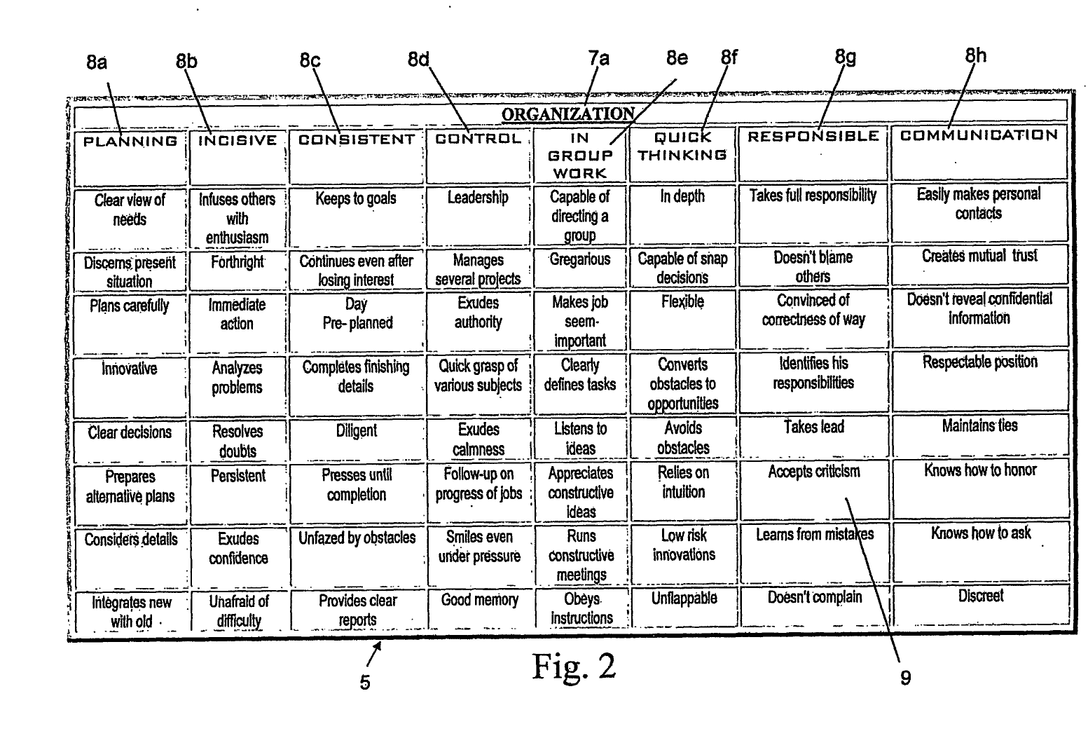

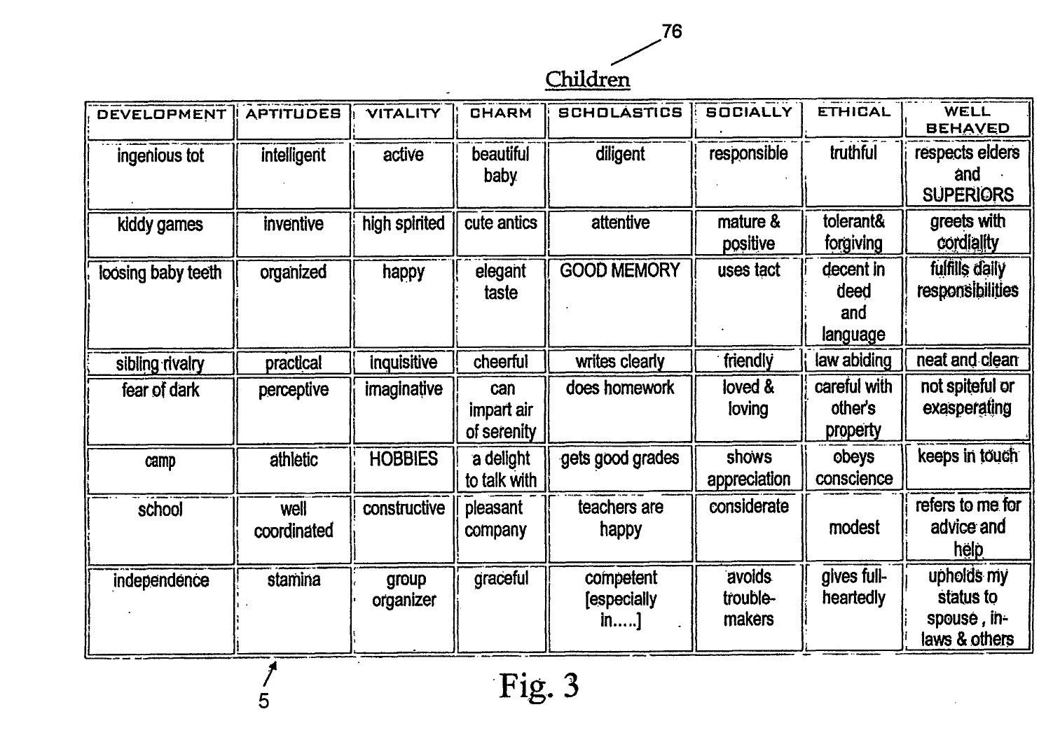

Each group is sub-divided into properties, e.g. eight properties, wherein each property is characteristic of the selected group. As illustrated in FIGS. 2 and 3, each group may be displayed by a secondary contentment source guide, generally indicated by numeral 5, which provides a list of properties associated with the selected group, and each property in turn is further sub-divided into a plurality of details, each of which allows a user to channel his memories to different facets of a selected property.

For example, the group of organization associated with the category of capabilities, as shown in FIG. 2, provides eight properties 8a-h: planning, incisive, consistent, control, in group work, quick thinking, responsible and communication, respectively. Property 8g of being responsible, for example, is defined by the details of takes full responsibility, does not blame others, convinced of correctness of way, identifies his responsibilities, takes lead, accepts criticism, learns from mistakes and does not complain. The detail of accepts criticism is indicated by numeral 9. When a contentment source guide 3 and a secondary contentment source guide 5 each provide 64 divisions, 4096 details of potential sources of contentment are listed. A user may pinpoint which of these details particularly provides a major source of contentment and accordingly may input and store information into a memory corresponding to the selected detail, so that the input information may be retrieved at a future time.

Similarly, the group of children associated with the category of dear ones, as shown in FIG. 3, provides eight properties: development, aptitudes, etc. The property of scholastics is defined by the details of diligent, attentive, good memory, etc. One of the details relates to the competency of a child in a certain field, and the user may advantageously complete in which field the child is competent and then input information relating to a way in which that child is competent in the selected field.

If so desired, a user may input information regarding all of the details cross-referenced by the contentment source guide. When appropriate following memorable events during the lifetime of the user, regardless of whether they provide a source of contentment, a description of events, according to the classification of the categories, groups, properties and details, as described hereinabove, are input. When the stored information is retrieved, the user will see that the total number of details which are sources of contentment far outweighs the total number of details which cause aggravation or unhappiness. By retrieving the stored information on a regular basis, a user may become accustomed to viewing his life from an optimistic perspective and may arrive at the realization that those details which cause aggravation play a minor role in his life. A user may therefore achieve a sense of contentment by understanding that his lifetime is predominantly replete with happy events.

The advantages of retrieving and reviewing information stored with a contentment source guide system, according to the present invention, are eight-fold:
1) Directs one's attention to positive aspects of his life. Most people have thousands of sources of contentment and no more than approximately one hundred sources of aggravation. By reviewing the stored information, the user receives a more optimistic perspective of his life.
2) Improves a level of contentment. During those moments that the user is reviewing his successes and happy memories, he improves his level of contentment.
3) Deemphasizes difficulties. People in pain tend to view that difficulty as a major aspect of their life. The user realizes, when reviewing details of his life divided into various groups and properties, that a certain difficulty is only one detail among a large number of sources of contentment, and usually is only temporary in nature.
4) Accentuates his self-importance. Many people determine their importance in terms of how others view them, such as how much money they earn, how much they are socially accepted, etc. The review of stored information in accordance with the present invention reveals many individual and independent characteristic traits, due to which a user may develop emotional stability by not being frustrated or upset if he is different than others. A user gradually strengthens his awareness in terms of his self-importance, and therefore tends to be less jealous of others and to be happy with the success of others.
5) Increases self-confidence. Frustration generally stems from criticism from others, striving for perfection, performance of tasks that are not compatible with his temperament, and jealousy of others. After inputting and retrieving details from the contentment source guide system, a user may define his strong points and the successes that he realized following his own initiatives and persistence. Consequently, a user develops confidence in performing tasks associated with those areas in which he succeeded, and since he has found his niche in life tends not to be frustrated.
6) Develops an affinity for humanitarianism. Many of the properties cross-referenced by the contentment source guide relate to interpersonal relationships. After reviewing the retrieved information that relates to such properties, a user tends to place importance in interacting with, and in assisting others.
7) Comfort. Information may be input and retrieved while in the comfort of one's home. A user may improve his level of contentment by contemplating various positive aspects of his life without having to expend an inordinate amount of time and money in traveling to group therapy sessions.
8) Privacy. Inputting and retrieving personal information via a contentment source guide system is conducted in complete privacy, and others who are not authorized cannot retrieve any stored information.

The information stored in the database of a contentment source guide system may be textual, audial and visual, as will be described hereinafter.

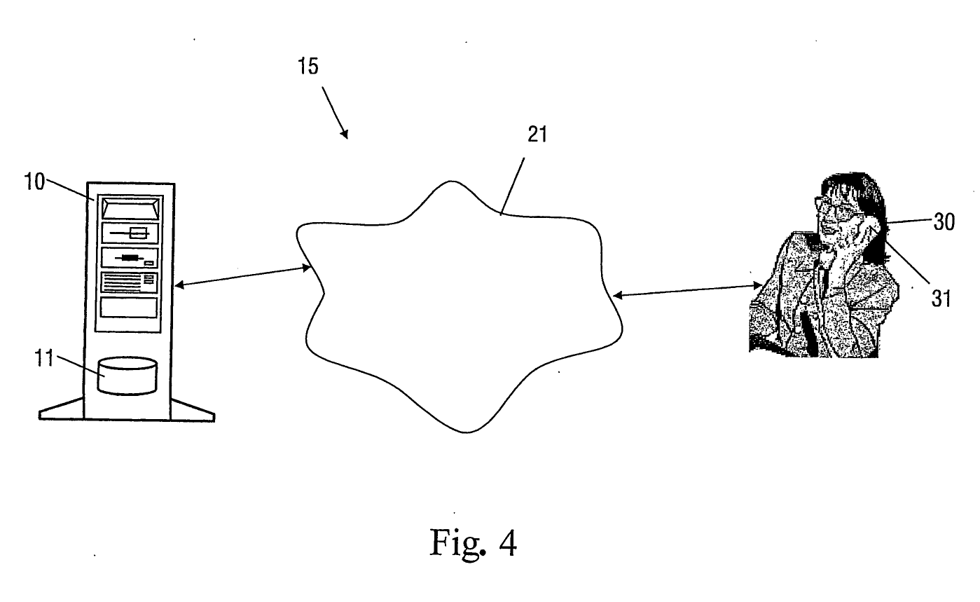

FIG. 4 schematically illustrates a contentment source guide system, generally indicated at 15, according to one preferred embodiment of the invention. Contentment source guide system 15 comprises computerized center 10 in communication with database 11 and telephonic user interface 31, through which user 30 communicates with computerized center 10 via telephone network 21. In this embodiment, the database is a plurality of voice mail cells, each of which stores a recorded message. The various voice mail cells are interrelated according to the hierarchy of the contentment source guide, namely, according to categories, groups, properties and details of sources of contentment.

The term Telephonic User Interface (TUI) refers herein to a user interface upon which the input is carried out by touch-tones, such as DTMF (Dual-Tone Multi-frequency). It will be appreciated that TUI 13 may be not just a conventional touch-tone telephone, but also may be a cellular telephone with a graphical menu that allows for browsing the various menus cross-referenced by the contentment source guide or secondary contentment source guide.

DTMF is the type of audio signal generated when pressing a button on a touch-tone telephone. With DTMF, the pressing of a button generates two tones of specific frequencies that are irreproducible by the human voice. One tone is generated from a high-frequency group and the other from a low-frequency group. Touch-tones can be decoded by hardware and/or software means referred to herein as a DTMF Decoder. The touch-tones are used as input means in user interface of telephone applications.

Due to the increased use of TUI, the Microsoft Company has developed the TAPI (Telephony Application Program Interface) as a standard interface for interacting with a computer system over a telephone or video phone.

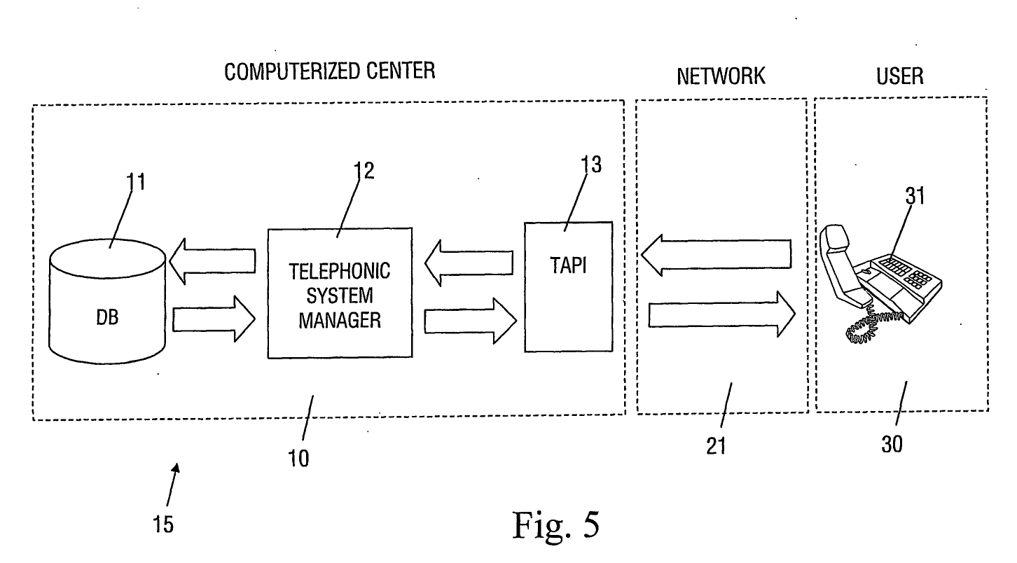

As illustrated in FIG. 5, computerized center 10 comprises database (DB) 11, for storing and retrieving information provided by user 30, telephonic system manager 12, for managing the transmission of information between user 30 and database 11 and TAPI 13, for communication between computerized center 10 and telephonic network 21. User 30 communicates with contentment source guide system 15 by listening to recorded information and by recording new information with use of a telephone handset of TUI 31, as well as by selecting an item listed in an audible menu when a desired touch key is pressed. If a video phone is employed, the user can output multimedia information to system 15 upon selecting an appropriate GUI provided with TUI 31. TAPI 13 digitizes and/or decodes an analog signal received from TUI 31, and transmits the corresponding digital signal to system manager 12.

System manager 12 manages the software associated with contentment source guide system 15, in accordance with the classification set forth in the contentment source guide and secondary contentment source guide. System manager 12 stores the information transmitted from user 30 in an appropriate cell of database 11. Each cell is assigned an address, and system manager 12 associates the assigned address with the contentment source detail defined by the user, which in turn is associated with a predefined property, group and category, as described hereinabove. After user 30 initiates a request for information retrieval, system manager 12 commands TAPI 13 to transmit the information stored at a corresponding address via network 21 to the user.

In order to communicate with computerized center 10, user 30, after dialing the correct telephone number, is requested to enter his user number, and then is usually also requested to enter his password by means of the touch keys. The user then indicates by an appropriate code whether he wishes to communicate with system 15 by a browsing mode whereby he listens to retrieved information or by an updating mode whereby he adds information to database 11. System manager 12 then transmits an audible menu listing the various categories of sources of contentment. After the user selects a category with which he wants to communicate, he is then requested to select a group, property and then detail.

If the user is in a browsing mode, all stored information associated with the selected detail is transmitted to TUI 31, one voice cell after another. After all information associated with the selected detail has been transmitted, the user is then requested to select another detail of the same property or to select the property menu of a previously selected group, so that another property and detail may be selected. If the user is in an updating mode, he records a message via the handset, and this message is stored in an appropriate voice cell. He then indicates by means of DTMF signals whether he wants to record a message associated with another detail. Of course, a user may effortlessly change from the browsing mode to the updating mode, upon selection of an appropriate code.

Contentment source guide system 15 may be adapted so as to allow another person to update information regarding user 30, without being accessible to the database in a browsing mode. For example, if a user continuously belittles himself concerning a certain aspect of his life, a relative may add information to the appropriate detail, so that the user will realize, upon browsing the said detail, that the belittlement is unfounded. A user may authorize only certain individuals to update the database.

In one preferred embodiment of the present invention, the audible menu transmitted from system manager 12 to user 30 lists only those divisions, namely, categories, groups, properties or details, for which information has been stored. The details cross-referenced by the contentment source guide system and by the secondary contentment source guide are representative of a majority of people for whom details resulting in happiness are predominantly more numerous, with respect to each group, than details causing aggravation and unhappiness. However, for some people, a specific group, or even a specific category, is liable to be a particular source of frustration or aggravation, such as the group of organization for a very disorganized person or the group of children for one who has not been able to bear children. Therefore, for such people, the system manager transmits an audible menu to the user which lists only those divisions for which information has been stored so that the user will not think of that particular source of frustration, and may improve his level of contentment. If so desired, e.g. by inputting a command to the system manager, all information stored in the database will be transmitted to the user according to the division in which it was stored.

In another preferred embodiment of the invention, a contentment source guide system may comprise an interactive television user interface (not shown), well known to those skilled in the art, which communicates by means of a cable modem with a television network of coaxial cables. A graphical menu is visible on a television screen and a desired listing is selected by pressing a key of the user interface. The user may update voice or video information to the database by means of the interactive television user interface and may retrieve the same when in a browsing mode. A video clip may improve the level of contentment of a user by visually emphasizing certain attributes, such as demonstrating his athletic or acting abilities. In this embodiment, the database is a plurality of multimedia mail cells, each of which stores a recorded message. The various voice mail cells are interrelated according to the hierarchy of the contentment source guide, and a graphical system manager of the computerized center of the contentment source guide system commands the TAPI to transmit the information stored at a corresponding address via the television network to the user.

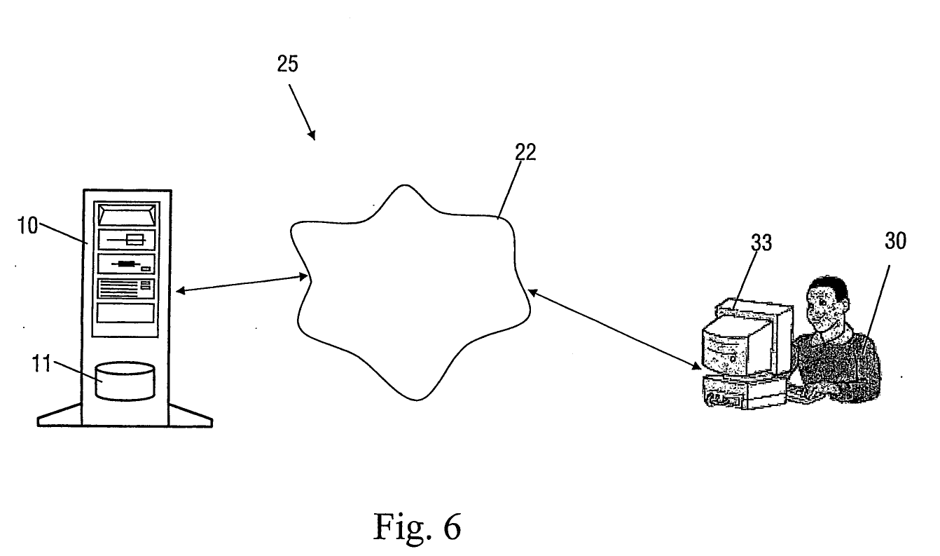

FIG. 6 schematically illustrates an Internet-based contentment source guide system, generally indicated at 25, for improving the level of contentment of a user, according to one preferred embodiment of the invention. User 30 communicates with computerized center 10 via Internet network 22 by means of Web terminal 33. Computerized center 10 is in communication with terminal 33 and with database 11, which, for this embodiment, is computer memory in which stored information is interrelated according to the hierarchy of the contentment source guide. Computerized center 10 functions as a Web site, and is therefore provided with a Web server.

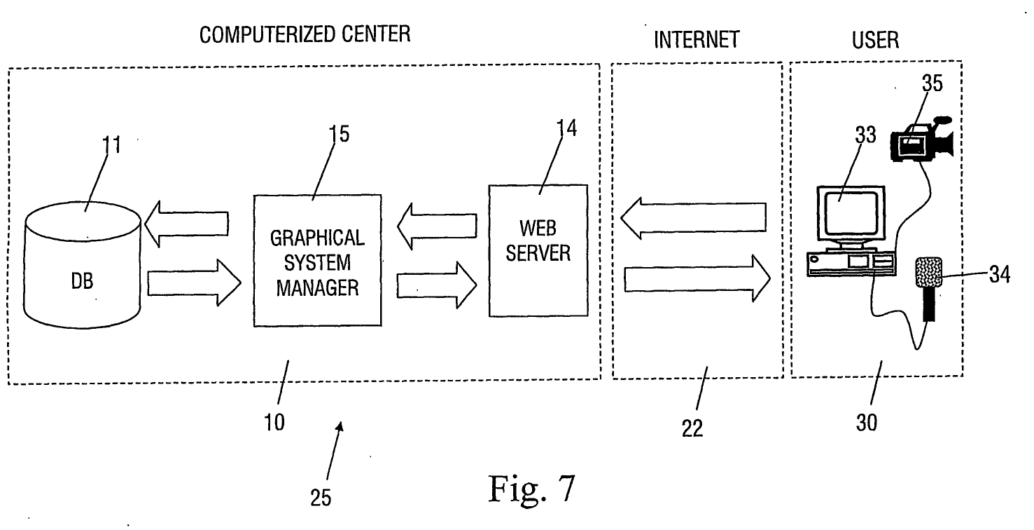

As illustrated in FIG. 7, computerized center 10 comprises database 11, for storing and retrieving information provided by user 30, graphical system manager 15, for managing the transmission of information between user 30 and database 11, and Web server 14, for communication between computerized center 10 and Internet 22. In order to access the information stored in database 11, a Web browser is executed on terminal 33. The information stored in database 11 may be textual or multimedia, e.g., voice and video. If the stored information is multimedia, peripheral equipment well known to those skilled in the art, such as microphone 34 and video camera 35, need to be coupled to terminal 33. Information may be communicated from a multimedia device to terminal 33 by recording the generated signal (e.g. voice and/or video) and by storing the recorded signal as a multimedia file (MPEG, JPEG, etc.). The multimedia file is then transmitted to computerized center 10 via Internet 22 and stored in database 11.

After loading web server 14, the user is requested to enter his user number and password. The user then indicates whether he wishes to communicate with system 25 by a browsing mode or by an updating mode. System manager 15 then transmits to terminal 33 via Internet 22 a contentment source guide which lists the various categories of sources of contentment. After the user selects a category with which he wants to communicate, he is then requested to select a group, property and then detail. A division selected from one hierarchal level of the contentment source guide is linked to a menu corresponding to the selected division of a lower hierarchal level.

If the user selects an updating mode, the user transmits the desired textual or multimedia information through Internet network 22. Web server 14 then receives the digital information from Internet 22. The digital information is transferred to system manager 15, which stores the information at a specific address within database 11. When in a browsing mode, interface 15 retrieves the desired digital information from database 11, which is transmitted by Web server 14 via Internet 22 and displayed by the browser on terminal 33.

A more sophisticated system can support both a telephonic interface and a Web interface. Thus, users can communicate with contentment source guide system 25 by their telephone equipment and/or their Web terminal.

It will be appreciated that this embodiment may be similarly adapted to be used in conjunction with an Intranet network.

According to another preferred embodiment of the invention, an entire contentment source guide system can be implemented with a personal computer, such that the database and the computerized center reside on said personal computer.

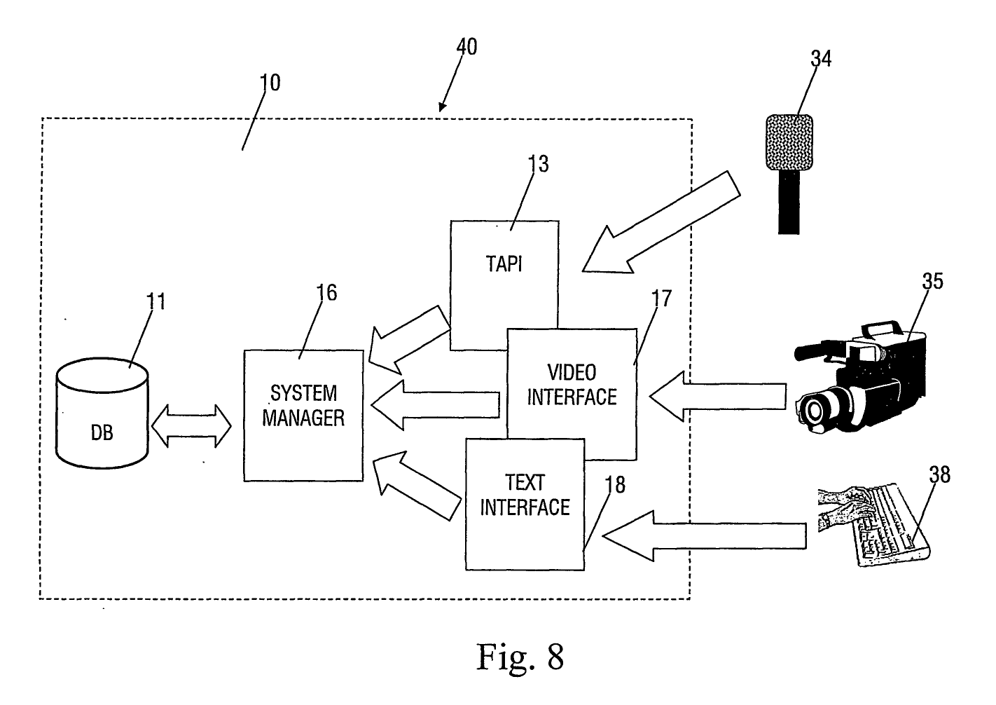

FIG. 8 schematically illustrates contentment source guide system 40, wherein an external database is not needed. Computerized center 10 which resides on a personal computer comprises database 11, in which textual and/or multimedia information may be stored, system manager 16, TAPI 13, video interface 17 and text interface 18. TAPI 13 communicates with the voice equipment (e.g. microphone 34), video interface 17 communicates with video camera 33, and keyboard 38 communicates with text interface 18, which is usually associated with the operating system of the personal computer. System manager 16 in turn communicates with database 11, TAPI 13, video interface 17 and text interface 18, whereby textual or multimedia information may be retrieved and stored according to the hierarchy of the contentment source guide.

It will be appreciated that a contentment source guide system may be licensed to organizations providing services relating to contentment enhancement, such as by a one-time charge, a periodical fee, and/or a resource usage fee (e.g., per online and/or disk usage). If the software of the computerized center is to be installed on a personal computer, various methods are available in the art, such as shareware, periodical fees, etc. Likewise the software can be distributed by a compact disk or downloaded from the Internet. Services provided remotely to a user typically require authentication before providing the service, such as user name/number and a password. The charges may be made via a conventional or cellular telephone company, if an appropriate contentment source guide system is employed.

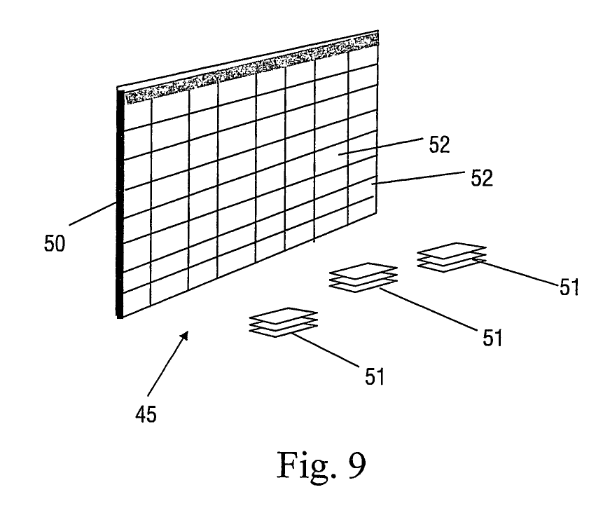

FIG. 9 schematically illustrates a card game, indicated generally by numeral 45, for improving a level of contentment, according to another preferred embodiment of the invention. Card game 45 comprises a plurality of boards 50 and a plurality of cards 51. Each board 50 is divided into a number of cells 52 arranged as a table of rows and columns, which may be implemented, e.g., as pockets or containers. The size of each card 51 is compatible with that of cells 52, such that a card can be placed within a cell 52 whereby it is completely visible when placed in position.

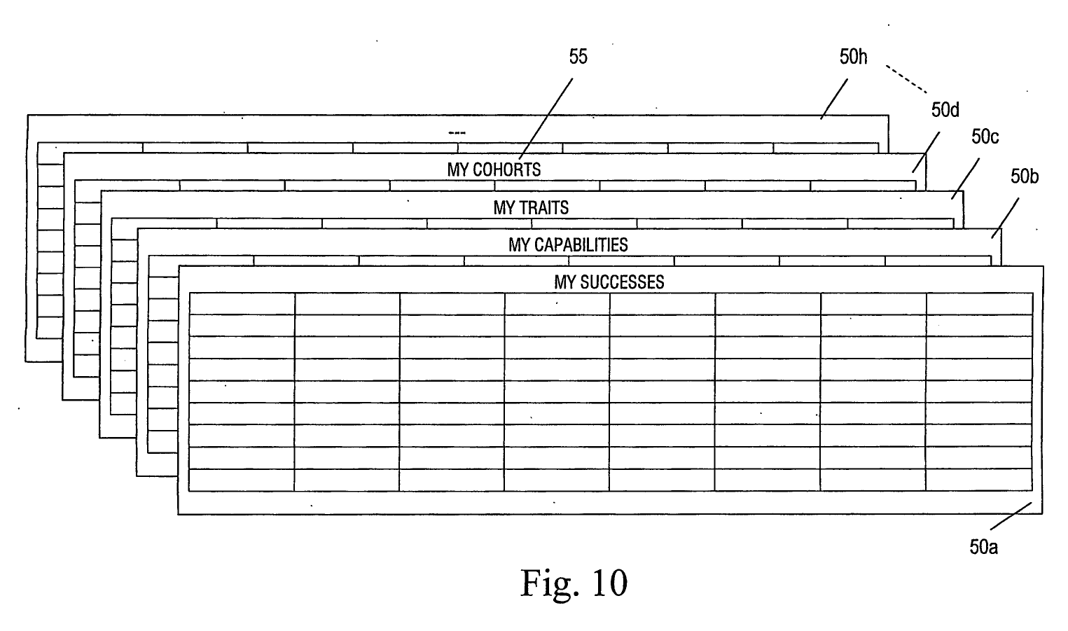

As shown in FIG. 10, each board 50a-h is entitled by a different category, and therefore can be used as a database. Each cell of top row 58 is defined by a different group associated with the selected category. If so desired, the remaining cells of the board may be defined by the properties corresponding to a particular group. The property definitions are advantageously visible even after the placement of a card 51, e.g. a definition label is adhered to a wall of a cell container. A player writes on a card 51 a positive aspect of his life, and stores it in an appropriate cell 52 according to the property definition. The cards may be retrieved, as in the digital implementation of the invention. The game may be provided without a definition of the upper row and of the cells, thereby allowing a player to introduce an individual group and property definition, instead of the predefined definitions.

Likewise, one board 50 may be employed, wherein each column represents a different category and a cell indicates a group, similar to the arrangement of FIG. 1. The cards which are inserted into a cell may then be associated with a particular group, whether on the order of a property or of a detail. Alternatively, cell definitions are not provided, so that one card may be placed in each cell and easily viewed during a browsing mode, whereby each cell reflects a different detail (or group or property) associated with a particular category.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A method for storing and retrieving personal information adapted to improve the level of contentment of a user, comprising:
a) Providing a database, for storing therein and retrieving therefrom information related to sources of contentment, each of said sources of contentment being associated with a different aspect of said user's life;
b) Determining categories by which said information is to be stored in and retrieved from said database;
c) Updating said database by storing information related to a source of contentment, said information being stored in a unique location of said database and categorized according to a definition of each of said categories;
d) Allowing said user to access one or more unique locations of said database in which categorized information of interest is stored;
e) Transmitting and/or displaying to a user interface, upon request from said user, said categorized information of interest; and
f) Reviewing said transmitted and/or displayed categorized information of interest.

2. A method according to claim 1, wherein the categorized information is arranged by divisions such that each category is divided into groups, each group being divided into properties and each property being divided into details.

3. A method according to claim 2, wherein the categorized information is transmitted and/or displayed after the user requests to browse the stored categorized information and selects a desired division from a list of corresponding divisions.

4. A method according to claim 3, wherein the list of divisions transmitted and/or displayed to the user lists only those divisions for which information has been stored.

5. A method according to claim 4, wherein all information stored in the database will be transmitted to the user, upon request from the user, according to the division in which it was stored.

6. A method according to claim 1, wherein the information is selected from the group of voice information, digital information, multimedia information and textual information.

7. A method according to claim 1, wherein the user interface is selected from the group of TUI (Telephonic User Interface), GUI (Graphical User Interface), an interactive television user interface and a text-based user interface.

8. A method according to claim 1, wherein the database is accessible through a data network.

9. A method according to claim 8, wherein the data network is selected from the group of a telephone network, an Internet network, an Intranet network, and a television network of coaxial cables.

10. A method according to claim 1, wherein authorization is required prior to updating the database or browsing the stored categorized information.

11. A method according to claim 10, wherein the database can be updated by authorized individuals, in addition to the user.

12. A method according to claim 2, wherein the database is at least one board adapted for use in a card game, each of said boards being divided into a number of cells which are arranged as a table of rows and columns, such that each cell corresponds to a different division of categorized information, whereby a player updates the database by placing a card on which is written information related to a source of contentment into a desired cell.

13. A method of claim 1, wherein the user becomes accustomed to viewing his life from an optimistic perspective by retrieving the stored categorized information on a regular basis.

14. A system for improving storing and receiving personal information adapted to improve the level of contentment of a user, comprising:
A database, for storing therein and retrieving therefrom categorized information related to sources of contentment, each of said sources of contentment being associated with a different aspect of said user's life;
A controller, for managing transmission of information between said user and said database;
A user interface for communicating with said controller; and
A contentment source guide transmitted by said controller to said user interface which lists divisions of categorized information upon selection of a desired type of division by said user, information being stored in and retrieved from said database according to a selected division included within a list of said desired type of division,
said controller being adapted to transmit from said database to said user interface, upon request from said user, stored categorized information according to each division selected by the user.

15. A system according to claim 14, wherein the divisions of categorized information are arranged by categories, each category being divided into groups, each group being divided into properties and each property being divided into details.

16. A system according to claim 14, wherein the information is selected from the group of voice information, digital information, multimedia information and textual information.

17. A system according to claim 14, wherein the user interface is selected from the group of TUI (Telephonic User Interface), GUI (Graphical User Interface), an interactive television user interface and a text-based user interface.

18. A system according to claim 14, wherein the database is accessible through a data network.

19. A system according to claim 18, wherein the data network is selected from the group of a telephone network, an Internet network, an Intranet network, and a television network of coaxial cables.

20. A system according to claim 14, wherein the contentment source guide is selected from the group of an audible menu, graphic menu and textual menu.

21. Systems according to claim 14, wherein the database, system manager and user interface are hosted by a personal computer.
